(19) United States
(12) Patent Application Publication
(10) Pub. No.: US 2008/0254791 A1
(43) Pub. Date: Oct. 16, 2008

(54) IMS COMMUNICATION NODE PROXIES AND METHODS

(75) Inventors: Johnson Oyama, Mississauga (CA); Nikos Katinakis, Mississauga (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/733,938

(22) Filed: Apr. 11, 2007

(51) Int. Cl. H04Q 7/20

(52) U.S. Cl. 455/435.1

(57) ABSTRACT

Systems and methods for splitting communication nodes to provide inter-domain functionality are described. For example, a home subscriber services (HSS) node can be split into a proxy node in a first domain and a non-proxy node in a second domain. The proxy node may or may not include a subset of the data available on the corresponding non-proxy node. An inter-domain interface, e.g., a GUP interface, can be employed between the proxy node and the non-proxy node and the inter-domain protocol server can be used to facilitate other interfaces, e.g., between a home location register (HLR) and other entities.

### TECHNICAL FIELD

The present invention relates generally to communications systems and in particular to methods and systems associated with IP Multimedia Subsystem (IMS) architectures.

### BACKGROUND

As the level of technology increases, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications. Similarly, in the entertainment industry, 30 years ago there was only one format for television and this format was transmitted over the air and received via antennas located at a home. This has evolved into both different standards of picture quality such as, standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user.

Another related technology that impacts both the communications and entertainment industries is the Internet. The physical structure of the Internet and associated communication streams have also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other IP networks) as a mechanism for providing traditional services. These multimedia services can include Internet Protocol television (IPTV, referring to systems or services that deliver television programs over a network using IP data packets), video on demand (VOD), voice-over-IP (VoIP), and other web related services.

To accommodate the new and different ways in which IP networks are being used to provide various services, new network architectures are being developed and standardized. One such development is the Internet Protocol Multimedia Subsytem (IMS) architecture. IMS is an architectural framework which uses a plurality of Internet Protocols (IP) for delivering IP multimedia services to an end user. A goal of IMS is to assist in the delivery of these services to an end user by having a horizontal control layer which separates the service layer and the access layer. More details regarding IMS architectures and various entities associated therewith are provided below.

One aspect of IMS architecture of particular interest for this application is that it has been created, as specified in the standards document 3GPP TS 23.228 IP “Multimedia Subsystem (IMS); Stage 2”, Version 8, March 2007, available for download at: http://www.3gpp.org/ftp/Specs/archive/23_series/23.228/, based on the premise that services would be sent for execution to the home domain mobile operator of a subscriber. As shown in FIG. 1, which depicts a subset of the entities involved in an IMS system, this, in turn, has led to the Home Subscriber Server (HSS) 18 and the Interrogating-Call Session Control Function (I-CSCF) 12 and the Serving-Call Session Control Function (S-CSCF) 14 being connected by essentially an intra-domain Cx interface. Note that, in FIG. 1, the standardized interfaces between communication nodes, described in the above-identified standards document, are denoted by their respective letter legends on the bidirectional arrows. The HSS 18 is a central repository or central access point for subscriber information which, for example, is used to establish sessions between users and to provide services to subscribers, and the I-CSCF 12 and S-CSCF 14 are session routing points in the IMS system which, for example, distribute incoming requests for service to application servers. Also shown in FIG. 1 is an IMS application server (AS) 20 and user equipment 22, the latter of which is receiving services from its home domain 16 via Proxy-Call Session Control Function (P-CSCF)/Session Border Gateway (SBG) 24. More information relating to these and other IMS entities is provided below.

However, requiring that the HSS 18 and I-CSCF 12, S-CSCF 14 be located within the same domain (e.g., home domain 16 which is owned or managed by the same company) limits the flexibility with which, for example, operators can structure their businesses. Additionally, since it has previously been assumed that the HSS 18 will also be located in the same domain as the Home Location Register (HLR, not shown in FIG. 1), an open, standardized interface has not been developed between the HSS 18 and the HLR (or the IMS AS 20 and HLR). This, in turn, has led to the assumption that the HSS 18 and the HLR will also be co-located to support, e.g., bi-directional Short Message Services (SMS) interworking (as, for example, described in the standards document 3GPP TS 23.204 “Support of SMS and MMS over generic 3GPP IP access; Stage 2; Release 7, Version 7.2.0, March 2007, available for download at: http://www.3gpp.org/ftp/Specs/html-info/23204.htm). If, however, the HSS 18 and the HLR are not co-located within the same domain, then the SMS interworking is essentially reduced to being only unidirectional

More specifically, an SMS message is preferably delivered where the dual-mode (i.e., Circuit Switched (CS) and IMS) user is currently attached, also taking into account operator and/or user preferences when the user is attached or registered in both CS domain and IMS domain simultaneously. Note that the CS domain components are not illustrated in FIG. 1. However, when the HLR and HSS 18 are located in different domains, it is not possible for the HSS 18 to quickly and easily convey the registration status of the user in IMS to the HLR. That is, there is no mechanism that enables the HLR to know when the user is actually registered in IMS, and where to send the SMS message to towards IMS. Thus, the HLR can only provide the address information of the Mobile Switching Center (MSC) that is currently serving the user on the CS side, and SMS messages sent from the CS side will have to be terminated on the CS side, and cannot be sent via the IMS domain even if the user is registered in IMS and prefers to receive SMS messages via IMS.

Accordingly, it would be desirable to provide methods and systems for permitting the HSS to be located in a domain other than that in which the I-CSCF, S-CSCF and/or HLR are located to provide for a more flexible system architecture and to facilitate bi-directional SMS messaging.

### SUMMARY

According to an exemplary embodiment, a communication system includes a proxy node including a processor for running an inter-domain application which provides functionality associated with a corresponding non-proxy node, which functionality includes a set of interfaces.

According to another exemplary embodiment, a method for registering in an IP Multimedia Subsystem (IMS) communication system includes the steps of: receiving, at a home subscriber service (HSS) proxy entity, an IMS registration information flow, forwarding, by the HSS proxy entity, the IMS registration information flow to an HSS node via an inter-domain protocol server, and returning IMS registration information from the HSS node.

According to another exemplary embodiment, a method for exchanging information between a home subscriber services (HSS) proxy node and a home location register (HLR) includes the steps of: connecting the HSS proxy node to a inter-domain protocol server, connecting the HLR to the inter-domain protocol server, and exchanging the information via the inter-domain protocol server.

According to still another exemplary embodiment, a home location register (HLR) includes a memory device for storing user data, wherein the HLR receives, and stores in the memory, short message service (SMS) routing information when a user connects to an IP Multimedia Subsystem (IMS) communication system from a Repository Access Function (RAF).

According to yet another exemplary embodiment, a method for providing an inter-domain, IP Multimedia System (IMS) service includes the steps of providing a first domain having a first set of IMS communication nodes, providing a second domain having a second set of IMS communication nodes, and providing the inter-domain, IMS service between the first domain and the second domain, wherein one of the IMS communication nodes disposed in the first domain stores a set of subscriber data used to provide the inter-domain, IMS service, and further wherein one of the IMS communication nodes disposed in the second domain stores a subset of the subscriber data used to provide the inter-domain IMS service.

### BRIEF DESCRIPTION OF THE DRAWINGS

The accompanying drawings illustrate exemplary embodiments, wherein:

FIG. 1 illustrates a conventional communication system;

FIG. 2 illustrates a process for registering user equipment in the system of FIG. 1;

FIG. 3 illustrates an exemplary communication system according to an exemplary embodiment;

FIG. 4 is a signaling diagram illustrating a process for registering user equipment in the system of FIG. 3;

FIG. 5 depicts a communication system according to another exemplary embodiment;

FIG. 6 is a signaling diagram illustrating SMS interworking according to yet another exemplary embodiment; and

FIG. 7 depicts a server structure according to an exemplary embodiment.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

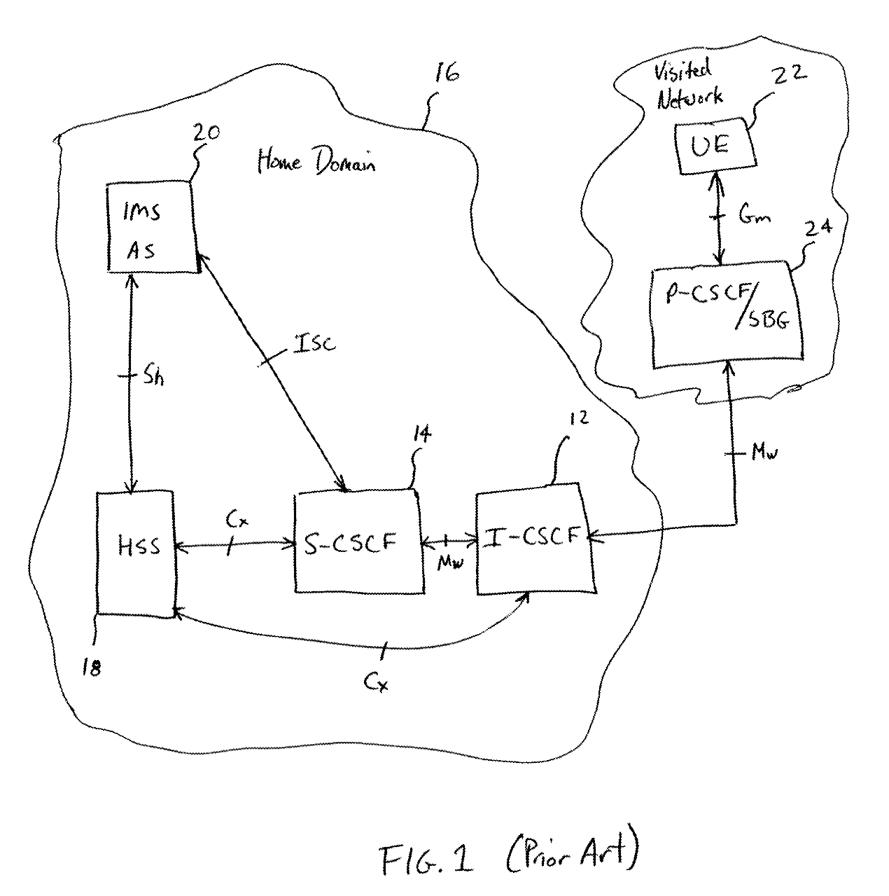

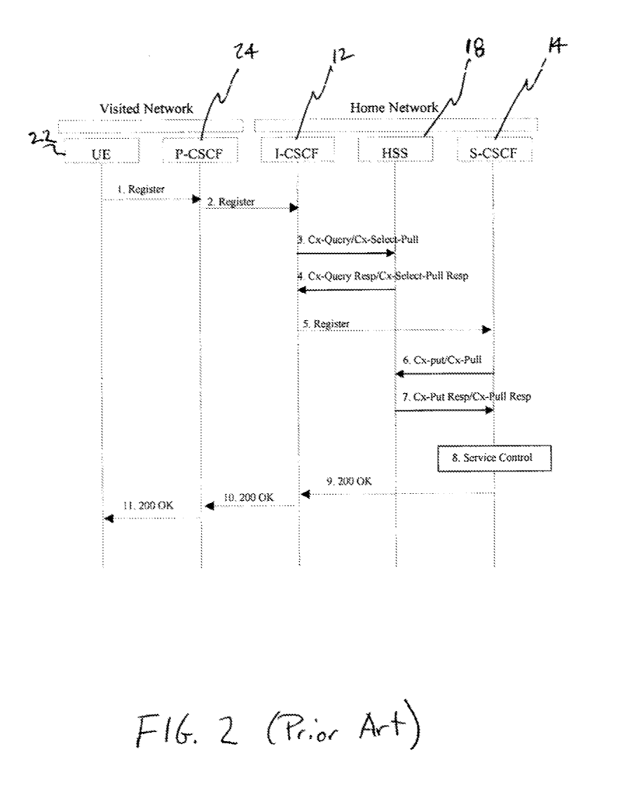

In order to provide some additional context for this discussion, a brief discussion regarding the manner in which user equipment (UE) 22 of FIG. 1 can register with the IMS system will first be provided with respect to FIG. 2. Therein, at signal 1, the UE 22 sends a registration request to the IMS system (P-CSCF 24) after it has obtained IP connectivity. The P-CSCF 24 evaluates the registration request to determine the address of the appropriate I-CSCF 12 and forwards the registration request to that I-CSCF 24 as signal 2. The I-CSCF 12, in turn, queries the HSS 18 regarding the registration request from the UE 22 in signal 3. The HSS 18, in response to the query, checks to see, for example, whether the user is registered already and whether that user is authorized to register in the visited network. The HSS 18 responds via signal 4 to inform the I-CSCF 12 whether the user is authorized to proceed with the registration and, if authorized, with an identifier associated with the appropriate S-CSCF 14 (or the S-CSCF capabilities for the I-CSCF to search for an appropriate S-CSCF).

Assuming that the user equipment 22 is authorized to register in the visited network, I-CSCF 12 will then continue the registration process by sending the registration message to the selected S-CSCF 14 as signal 5. The selected S-CSCF 14, in turn, sends a Cx-Put/Pull message to the HSS 18 as signal 6, including the public/private user identity associated with user equipment 22 and its S-CSCF name. The HSS 18 stores the received session information and returns, via signal 7, user information to the S-CSCF 14 including, for example, information usable to access service control platforms(s) while this particular user is registered at this S-CSCF 14. As indicated by step 8, the SCSF 14 can then send registration information to the service control platform(s) (not shown) and perform service control functions, as needed. Acknowledgement of the successful registration is returned through the IMS network to the UE 22 via signals 9-11.

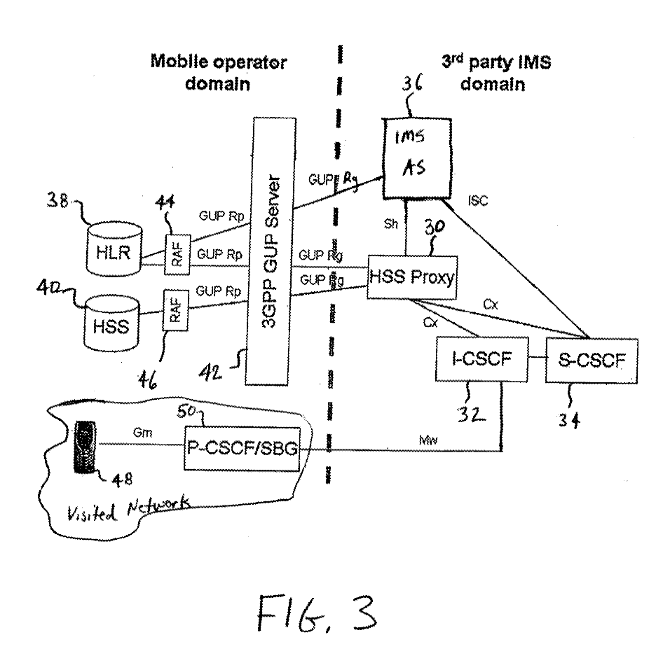

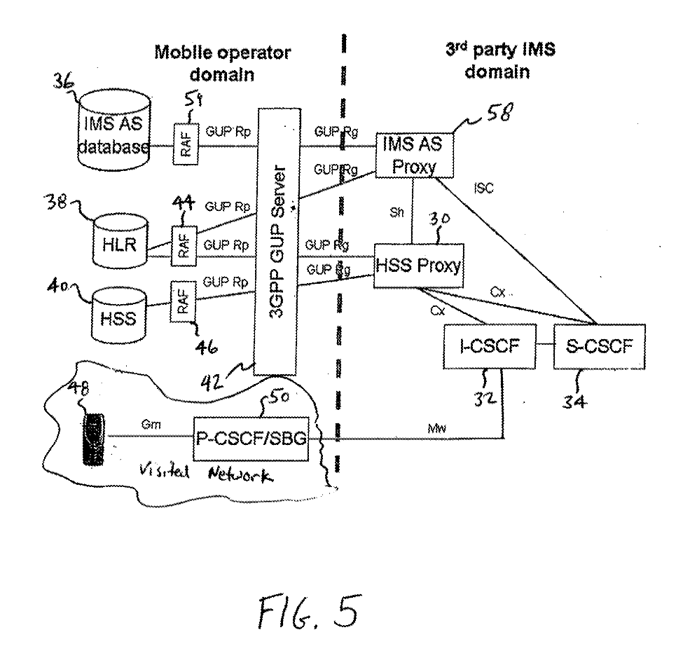

As mentioned above, it would be desirable to provide more flexibility to the network architecture than is currently available in IMS systems wherein the HSS 18 is co-located with (e.g., in the same domain as), for example, the I-CSCF 12 and S-CSCF 14. Thus, according to exemplary embodiments, an HSS Proxy 30 can be provided as shown in the system of FIG. 3. Therein, the HSS Proxy 30 is co-located, i.e., in the same domain as, the I-CSCF 32 and S-CSCF 34 and is connected to those entities as well as to an IMS AS 36, HLR 38 and HSS 40. According to this exemplary embodiment, the IMS AS 36 is co-located with the HSS Proxy 30, however other exemplary embodiments (described below with respect to FIG. 5) provide for the IMS AS 36 to be a split entity in a manner similar to that provided for the HSS in the embodiment of FIG. 3. Additionally, although FIG. 3 depicts the operator's domain as “mobile”, these exemplary embodiments are equally applicable to systems wherein the operator's domain is associated with fixed system equipment. Moreover, as used herein, the term “domain” refers to a set of functions, communication nodes and/or entities which are under the control of, managed by and/or owned by, a single entity, e.g., a corporate entity or enterprise such as an operator, including, but not limited to mobile virtual network operators (MVNO), or service provider.

According to these exemplary embodiments, the HSS Proxy 30 is intended to operate in much the same way as the HSS 40, but allows all or part of the HSS 40 to be located within, e.g., the mobile operator domain, instead of, e.g., a 3rd party's IMS domain. In particular, it may be desirable to provide for all or part of the user data associated with the HSS entity to be located within one domain, while providing a proxy in another domain(s) that satisfies the standardized functionality for the HSS. Thus, the HSS Proxy 30 will have a plurality of interfaces available for the nodes which expect to connect to HSS 40, e.g., a first Cx interface for connecting the HSS Proxy 30 to the I-CSCF 32, a second Cx interface for connecting the HSS Proxy 30 to the S-CSCF 34 and an Sh interface for connecting the HSS Proxy 30 to the IMS AS 36. As mentioned earlier, the Cx and Sh interfaces are further described in 3GPP TS 23.228 IP “Multimedia Subsystem (IMS); Stage 2”, Version 8, March 2007. For example, the Cx interface is a local domain's data exchange interface. The Sh interface is an interface which transports transparent data associated with, e.g., service related data and user related information. Among other things, these features of HSS Proxy 30 according to this exemplary embodiment provide for the delivery of services across domains (such as multiple operators) without requiring that the subscriber data reside in both entity networks.

In order to act as a proxy for the actual HSS 40, HSS Proxy 30, according to this exemplary embodiment, can be a server running an HSS proxy application which operates as a Generic User Profile (GUP) application and, therefore, supports an Rg reference point protocol interface to a GUP server 42. The Rg reference point interface is provided to control the data stored in the different GUP components associated with GUP server 42, which components are identified by a resource identity and the component type. GUP architectures and applications address issues associated with the distribution of data associated with a user across various domains within, e.g., a 3GPP mobile system. Thus, the 3GPP GUP standards document, promulgated by 3GPP as TS 23.240 (3GPP Generic User Profile (GUP); Architecture (Stage 2)), Release 6, v. 6.7.0, March 2005, available for download at: http://www.3gpp.org/ftp/Specs/archive/23_series/23.240/, the disclosure of which is incorporated here by reference, provides an architecture, data description and interface with mechanisms to address these data handling issues. The GUP server 42 interfaces with the HLR 38 and the HSS 40 via Rp reference point interfaces and Repository Access Functions (RAFs) 44 and 46, respectively. The RAFs 44 and 46 provide protocol and data transformation into the GUP infrastructure.

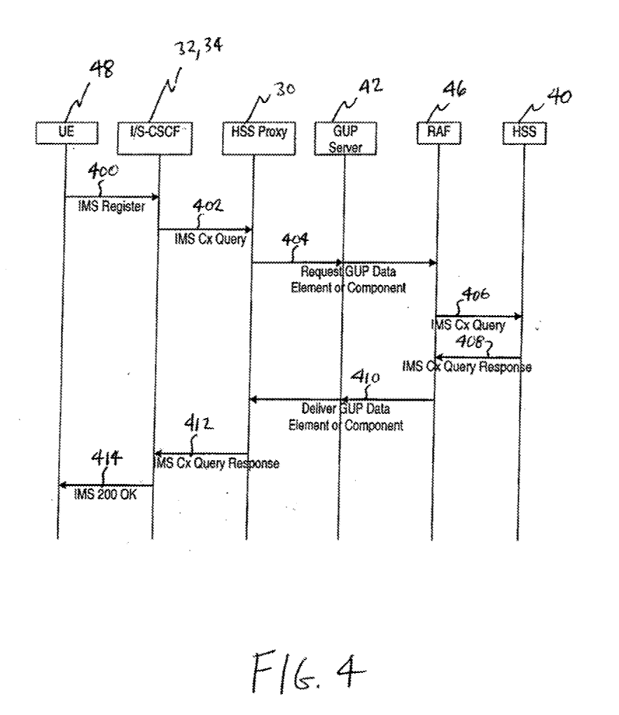

User equipment (UE) 48 connects through to its home (e.g., mobile operator) domain via P-CSCF/SBG 50 from a visited network. Registration of the user equipment 48 in systems using an HSS Proxy 30 can be performed according to exemplary embodiments as shown in the signaling diagram of FIG. 4. Therein, at signal 400, after the UE 48 obtains IP connectivity with an IP network (not shown), it transmits an IMS register information message/information flow toward the I/S-CSCFs 32, 34 including, e.g., public/private user identity information, home network domain name, and its IP address. The I-CSCF 32 sends an IMS Cx Query 402 to the HSS Proxy 30 (rather than directly to the HSS as described above with respect to FIG. 2). The HSS Proxy 30 transforms the IMS Cx Query into a Request GUP Data Element or Component message 404 which is then sent over the Rg reference point interface to the GUP server 42. The GUP server 42 forwards message 404, via the Rp reference point interface, to RAF 46 where it is transformed back into an IMS Cx Query message 406 for transmission to the actual HSS 40.

Upon receipt, the HSS 40 stores the S-CSCF name associated with the user equipment 48 and returns the information flow 408 to that S-CSCF 34 including information which can be used to access platform(s) for service control and security information. The information flow 408 is received by the RAF 46 and converted into a Deliver GUP Data Element or Component message 410. Message 410 is sent to the GUP server 42, via the Rp reference point interface, and forwarded onto the HSS proxy 30 via the Rg reference point interface. The HSS proxy 30 transforms the message 410 into an IMS Cx Query Response message 412 which, for example, includes the access platform address information and/or security information provided by HSS 40. The I-CSCF 32 forwards an acknowledgement signal back through P-CSCF/SBG 50 to the user equipment 48 indicating that registration has been successful.

Thus, the foregoing registration process illustrates how an HSS Proxy 30 according to these embodiments provides a transparent mechanism (from the point of view of the other IMS entities) for providing HSS functionality within a first domain, while actually locating the HSS database within a second, different domain (i.e., an inter-domain HSS). The HSS Proxy 30 may operate as a pass-through mechanism which does not store any user data itself but simply passes information flows to and from the HSS 40. Alternatively, the HSS Proxy 30 may, according to some exemplary embodiments, operate as a subtending HSS which accesses or stores a subset of the data which is stored in the HSS 40 to allow a secondary carrier/operator to directly provide services offered by a main carrier/operator, while still providing the main carrier/operator with ownership and control over the complete HSS 40's database.

This technique according to exemplary embodiments of splitting entities in a manner which enables data sets and/or associated functionality to be flexibly positioned in any desired domain is not limited to HSS functionality and data. For example, as briefly mentioned above, according to another exemplary embodiment the database associated with IMS AS 36 may also be removed from the domain containing, e.g., the I-CSCF 32 and S-CSCF 34, and disposed in the same domain as the HLR 38 and HSS 40. This can be accomplished by, as shown in the exemplary embodiment of FIG. 5 (wherein the same reference numerals are used to describe similar elements as those described above with respect to FIGS. 3 and 4), providing an IMS AS Proxy 58. The IMS AS Proxy 58 appears, e.g., to the S-CSCF 34, as if it were in fact the IMS AS 36, e.g., it supports communications via an IMS Service Control (ISC) interface to the S-CSCF 34 and via an Sh interface with the HSS Proxy 30. The ISC interface supports, for example, subscription to event notifications between the IM AS Proxy 58 and S-CSCF 34 to allow the IM AS 36 to be notified of, for example, the implicit registered Public User Identities, registration state and UE capabilities and characteristics in terms of SIP User Agent capabilities and characteristics. Like the HSS Proxy 30, the IMS AS Proxy 58 can run on a server as a GUP application which supports the Rg reference point protocol towards the GUP server 42, via which it connects to the actual IMS AS database 36. The IMS AS Proxy 58 may or may not execute application logic on behalf of the IMS AS (database) 36, e.g., associated with the provision of the particular IMS application service associated with database 36 such as IPTV or VoIP.

The IMS AS Proxy 58 thus may operate as a pass-through mechanism which does not store any application service data itself but simply passes information flows to and from the IMS AS (database) 36. Alternatively, the IMS AS Proxy 58 may, according to some exemplary embodiments, operate as a subtending IMS AS which accesses or stores a subset of the data which is stored in the IMS AS database 36 to allow a secondary carrier/operator to directly provide services offered by a main carrier/operator, while still providing the main carrier/operator with ownership and control over the complete IMS AS 36's database. Additionally, IMS Proxy 58 can be provided in systems with do not employ an HSS Proxy 30. More generally, any IMS communication node can be partitioned into a proxy node and a non-proxy node using the afore-described techniques. Such a proxy communication node can, for example, include a processor running a GUP application which provides services which are a subset of those services provided by the corresponding non-proxy node. In some cases the subset can be quite limited, e.g., a corresponding set of interfaces to other communication nodes which expect to be able to connect with the non-proxy node. In other cases the subset can be more substantial, e.g., including a reduced data set and/or application functionality set.

The exemplary architectures illustrated in FIGS. 3 and 5 also enable the HSS Proxy 30 (and/or the IMS Proxy 58) to connect with the HLR 38 in an open and standardized way using the GUP architecture, e.g., via GUP server 42 and its associated Rg and Rp reference point interfaces and RAF 44. Thus, the HSS Proxy 30 can send information and messages to the HLR 38 regarding the status of the subscriber in the IMS domain. Similarly, the HSS Proxy 30 can obtain information and messages from the HLR 38 regarding the status of the subscriber in the circuit-switched and/or packet switched domain. A specific example illustrating how this connectivity between the HSS Proxy 30 and HLR 38 according to these exemplary embodiments can be used is provided below with respect to a Short Message Service (SMS). It should noted that although SMS services are used herein as an example of a service which may benefit from these exemplary embodiments, other cross domain services will likewise benefit therefrom.

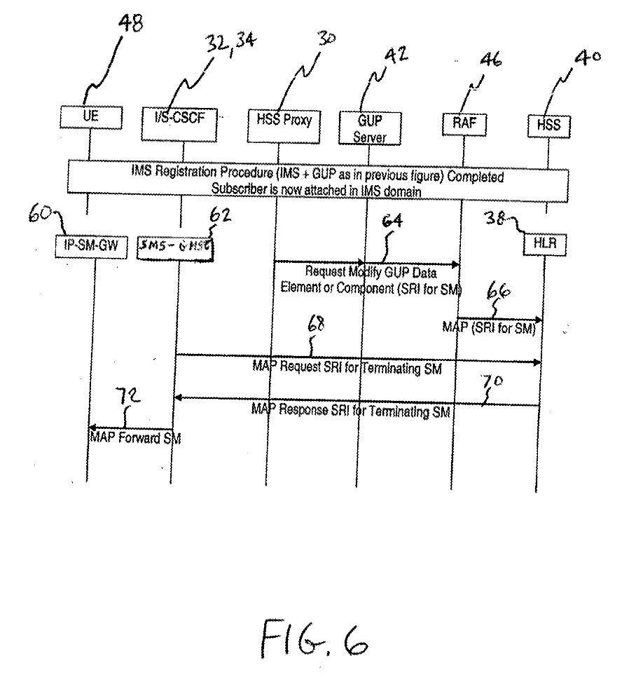

FIG. 6 illustrates various signaling associated with bi-directional SMS interworking according to an exemplary embodiment. In addition to the other communication nodes described above, FIG. 6 also includes two SMS specific nodes: an IP Short Message Gateway (IP-SM-GW) 60 and a Short Message Service Gateway Mobile Switching Center (SMS-GMSC) 62. The IP-SM-GW 60 provides the protocol interworking for delivery of short messages between the IP-based UE 38 and a service center (SC, not shown) and is connected to, among other entities, S-CSCF 34 via an ISC interface. The SMS-GMSC 62 provides an interface between the SC (not shown) and the IP-SM-GW 60 (via an E/Gd interface).

As shown in FIG. 6, when the user attaches or registers with the IMS domain, the HSS Proxy 30 sends the address of the IP-SM-GW 60 in an SRI (Send Routing Information) for SM (Short Message) information element to the RAF 46 via GUP protocols. The RAF 46 conveys the SRI for SM information 64 to the HLR 38 via a MAP interface as signal 68. The HLR 38 caches this information which indicates the address to which SMSs for that user are to be sent in response to queries from the SMS-GMSC 62. When an SMS finally comes (from the CS side), this gets routed to the SMS-C which queries, via the MAP interface as signal 68, the HLR 38 for the SRI for SM information to route the SMS to the user. The HLR 38 provides the cached SRI for SM information via MAP response 70, which information is the address of the IP-SM-GW 60, and the SMS gets delivered via the IMS domain. Thus, according to this exemplary embodiment, the connectivity between the HSS proxy 30 and the HLR 38 via the GUP server 42, provides a mechanism for the HLR 38 to know when the user is actually registered in IMS, and also the corresponding address used by the SMS-GMSC for routing the SMS message to that user via the IMS system.

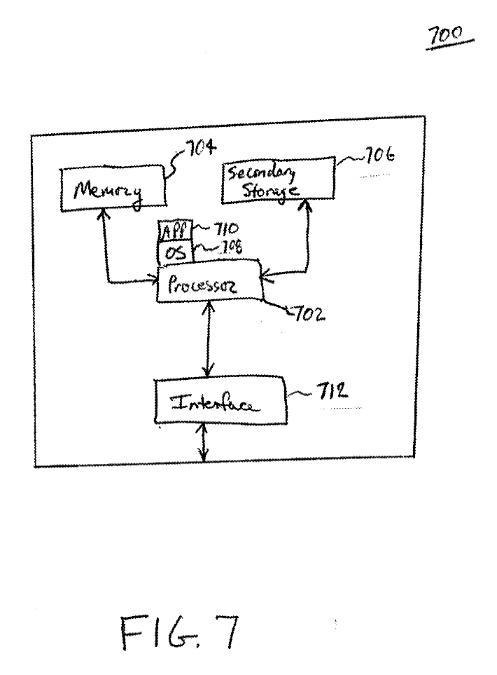

Some of the communication nodes described above, e.g., the HSS proxy node, IMS AS proxy node, etc., may be implemented as servers. For example, as shown generally in FIG. 7, such a server 700 can include a processor 702 (or multiple processor cores), memory 704, one or more secondary storage devices 706, an operating system 708 running on processor 702 and using the memory 704, as well as a corresponding application 710, e.g., a GUP application providing HSS proxy functionality or IMS AS functionality. An interface unit 712 may be provided to facilitate communications between the server 700 and the rest of the network(s) or may be integrated into the processor 702.

In the foregoing exemplary embodiments, GUP applications, servers and interfaces have been described for facilitating communications between proxy nodes and corresponding non-proxy nodes. However, those skilled in the art will appreciate that other appropriate inter-domain protocols or applications can be used as alternatives to GUP, e.g., AAA protocols such as DIAMETER or RADIUS. Thus, according to exemplary embodiments, a proxy node can include a processor for running an inter-domain application, e.g., a GUP application, which provides functionality associated with a corresponding non-proxy node, that functionality including a set of interfaces, e.g., to support operation as an HSS proxy node or an IMS AS proxy node.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A communication system comprising:
a proxy node including a processor for running an inter-domain application which provides functionality associated with a corresponding non-proxy node, said functionality including a set of interfaces.

2. The communication system of claim 1, wherein said inter-domain application is one of: a GUP application, a DIAMETER application and a RADIUS application.

3. The communication system of claim 1, wherein said corresponding non-proxy node is a home subscriber server (HSS) node, which HSS node is a repository for subscriber information which is used to establish sessions between users and to provide services to subscribers in an IP Multimedia communication System (IMS), and
wherein said set of interfaces includes a first local domain data exchange interface, a second local domain data exchange interface and a third interface which provides for control of data stored in different components associated with said inter-domain application.

4. The communication system of claim 3, wherein
said proxy node is connected to an Interrogating-Call Session Control Function (I-CSCF) via a first Cx interface;
said proxy node is connected to a Serving-Call Session Control Function (S-CSCF) via a second Cx interface; and
said proxy node is connected to a GUP server via a Rg reference point interface.

5. The communication system of claim 3, wherein said proxy node further comprises at least one memory device, wherein said at least one memory device stores a subset of the subscriber information associated with said HSS node.

6. The communication system of claim 1, wherein said communication system also includes said corresponding non-proxy node and further includes a GUP server connected between said proxy node and said corresponding non-proxy node.

7. The communication system of claim 6, further comprising a home location register (HLR) connected to said proxy node via said GUP server.

8. The communication system of claim 6, wherein said proxy node and said corresponding non-proxy node are located in different domains.

9. The communication system of claim 1, wherein said corresponding non-proxy node is an IP Multimedia communication System application server (IMS AS) which provides a service to a subscriber, and
wherein said set of interfaces includes a first interface for supporting subscription to event notifications, a second, intra-operator interface which transports transparent data and a third interface which provides for control of data stored in different components associated with said inter-domain application

10. The communication system of claim 9, wherein
said proxy node is connected to a Serving-Call Session Control Function (S-CSCF) via an ISC interface;
said proxy node is connected to one of a home subscriber services (HSS) node and an HSS proxy node via an Sh interface; and
said proxy node is connected to a GUP server via an Rg reference point interface.

11. The communication system of claim 9, wherein said service is one of IPTV and VoIP.

12. A method for registering in an IP Multimedia Subsystem (IMS) communication system:
receiving, at a home subscriber server (HSS) proxy entity, an IMS registration information flow,
forwarding, by said HSS proxy entity, said IMS registration information flow to an HSS node via an inter-domain protocol server, and
receiving IMS registration information from said HSS node.

13. The method of claim 12, further comprising:
connecting said HSS proxy entity to an Interrogating-Call Session Control Function (I-CSCF) via a first Cx interface;
connecting said HSS proxy entity to a Serving-Call Session Control Function (S-CSCF) via a second Cx interface; and
connecting said HSS proxy entity to a GUP server via a Rg reference point interface.

14. The method of claim 12, wherein said HSS proxy entity contains a subset of the data stored in said HSS node.

15. The method of claim 12, wherein said HSS proxy entity is located in a first domain and said HSS node is located in second domain different from said first domain.

16. The method of claim 12, further comprising:
exchanging information between said HSS proxy entity and a home location register (HLR) via said inter-domain protocol server.

17. The method of claim 16, wherein said HLR is located in said second domain.

18. The method of claim 12, wherein said inter-domain protocol is one of: Generic User Profile (GUP), RADIUS and DIAMETER.

19. A method for exchanging information between a home subscriber services (HSS) proxy node and a home location register (HLR) comprising:
connecting said HSS proxy node to an inter-domain protocol server;
connecting said HLR to said inter-domain protocol server; and
exchanging said information via said inter-domain protocol server.

20. The method of claim 19, wherein said information includes a send routing information for short message (SRI-SM) information element.

21. The method of claim 19, wherein said information includes an address of an IP Short Message Gateway (IP-SM-GW).

22. The method of claim 20, further comprising:
providing from said HLR, in response to a MAP request for terminating short message, said SRI-SM information element to a Short Message Service Gateway Mobile Switching Center (SMS-GMSC); and
forwarding, by said SMS-GMSC, a short message to an IP Short Message Gateway (IP-SM-GW) using said SRI-SM.

23. The method of claim 19, wherein said inter-domain protocol is one of Generic User Profile (GUP), DIAMETER and RADIUS.

24. A home location register (HLR) comprising:
a memory device for storing user data;
wherein said HLR receives, and stores in said memory, short message service (SMS) routing information when a user connects to an IP Multimedia Subsystem (IMS) communication system from a Repository Access Function (RAF).

25. A method for providing an inter-domain, IP Multimedia System (IMS) service comprising:
providing a first domain having a first set of IMS communication nodes;
providing a second domain having a second set of IMS communication nodes;
providing said inter-domain, IMS service between said first domain and said second domain,
wherein one of said IMS communication nodes disposed in said first domain stores a set of subscriber data used to provide said inter-domain, IMS service, and
further wherein one of said IMS communication nodes disposed in said second domain stores a subset of said subscriber data used to provide said inter-domain IMS service.

26. The method of claim 25, wherein said inter-domain, IMS service is a short message service (SMS).

27. The method of claim 25, wherein said inter-domain, IMS service is not a short message service (SMS).

28. The method of claim 25, wherein said one of said IMS communication nodes disposed in said first domain is a home subscriber services (HSS) node and wherein said one of said IMS communication nodes disposed in said second domain is an HSS proxy node.
